(19) United States
(12) Patent Application Publication
(10) Pub. No.: US 2025/0368094 A1
(43) Pub. Date: Dec. 4, 2025

(54) AUTOMOBILE FRONT SEAT

(71) Applicant: Adient (Chongqing) Automotive Components Co., Ltd., Chongquing (CN)

(72) Inventors: Tianlong LIU, Chongqing (CN); Qihong YI, Chongqing (CN); Zhiyong CHEN, Chongqing (CN); Wei JIA, Chongqing (CN); Hongwei TAN, Chongqing (CN)

(73) Assignee: Adient (Chongqing) Automotive Components Co., Ltd., Chongquing (CN)

(21) Appl. No.: 19/223,989

(22) Filed: May 30, 2025

(30) Foreign Application Priority Data
Jun. 3, 2024 (CN) 202410706096 .7
Jun. 3, 2024 (CN) 202421250732.1

(51) Int. Cl. B60N 2/02; B60N 2/06; B60N 2/16; B60N 2/20

(52) U.S. Cl. CPC B60N 2/02253; B60N 2/06; B60N 2/1615; B60N 2/164; B60N 2/20

(57) ABSTRACT

An automobile front seat may have a sliding rail assembly having a lower sliding rail module and an upper sliding rail module. The upper sliding rail module may have an adapter component. A backrest framework may be rotatably mounted on the adapter component. A first driving assembly that rotates the backrest framework may be on the backrest framework. A seat cushion framework may be on the upper sliding rail module. A height adjustment mechanism may be used for the seat cushion framework to move vertically relative to the upper sliding rail module. A front-rear adjustment mechanism may be located between the seat cushion framework and the upper sliding rail module. The front-rear adjustment mechanism may be used for driving the seat cushion framework to move forward and backward relative to the upper rail module

### TECHNICAL FIELD

The present invention relates to the technical field of automobile seats and in particular to an automobile front seat.

### BACKGROUND ART

The automobile seat is one of the most important components of an automobile; it can provide a comfortable and safe riding position for a driver. With the expansion of the automobile market, both automobile manufacturers and consumers have placed more stringent demands on the comfort of automobile seats.

The backrests of some of the front seats on the market have a forward tipping function, which can increase the space for the rear passenger to move, allowing them to support their legs on the backrest of the front seat when resting. However, in existing seat structures, the backrest of the front seat is typically rotatably mounted at the rear end of the seat cushion frame, and, when the backrest is rotated forward, the seat cushion is stationary relative to the backrest, and the backrest cannot be flattened forward at a large angle, due to interference from the seat cushion, resulting in limited space for the rear passenger to move and less comfortable support for the passenger's legs. To this end, the applicant intends to increase the folding space under the backrest by moving the seat cushion individually forward so that the backrest can be flattened forward at a large angle. However, in this development framework, to give the seat cushion an individual forward moving function requires additional transmission components, making it difficult to also give consideration to the height adjustment function of the seat cushion. The elimination of the height adjustment function will result in a significant reduction in the utility and comfort of the seat.

Therefore, how to integrate the seat cushion forward moving function and height adjustment function in the same seat has now become a technical problem to be urgently solved.

### SUMMARY OF THE INVENTION

In view of this, the present invention provides an automobile front seat, the seat cushion of which can have both forward moving and height adjustment functions, having the advantages of strong practicality and good comfort.

To achieve the abovementioned objective, technical solutions of the present invention are as follows:

An automobile front seat, characterized by comprising:
a sliding rail assembly, the sliding rail assembly comprising a lower sliding rail module and an upper sliding rail module slidingly arranged on the lower sliding rail module, the lower sliding rail module being used for fitting to an automobile floor, and a rear end of the upper sliding rail module being fixedly provided with an adapter component that extends upward;
a backrest framework that is rotatably mounted on the adapter component, a first driving assembly being provided on the backrest framework, and the first driving assembly being used for driving the backrest framework to rotate forward or backward;
and a seat cushion framework that is located on an upper side of the upper sliding rail module, a height adjustment mechanism being provided between the seat cushion framework and the upper sliding rail module, the height adjustment mechanism being used for driving the seat cushion framework to move vertically relative to the upper sliding rail module, a front-rear adjustment mechanism being provided between the seat cushion framework and the upper sliding rail module, and the front-rear adjustment mechanism being used for driving the seat cushion framework to move forward and backward relative to the upper rail module.

With the above structure, the seat cushion framework and the backrest are fitted to different structural bases of the upper sliding rail module, and the seat cushion framework as a whole can be driven to move forward individually by the front-rear adjustment mechanism, thereby eliminating interference with the space under the backrest framework, providing the backrest framework with space to fold forward, enabling the backrest framework to be flattened forward at a large angle. The seat cushion framework can be driven to move vertically by the height adjustment mechanism, which can realize a height adjustment function of the seat cushion framework, ensuring riding comfort of the front passenger.

Preferably, the lower sliding rail module comprises a first lower rail and a second lower rail arranged in parallel, and the upper sliding rail module comprises a first upper rail and a second upper rail slidably connected to the first lower rail and the second lower rail, respectively;

The front-rear adjustment mechanism comprises a first connecting rod that is arranged between a front part of the seat cushion framework and the first upper rail, two ends of the first connecting rod being respectively hingedly connected to the front part of the seat cushion framework and the first upper rail, a second connecting rod being provided between a rear part of the seat cushion framework and the first upper rail, two ends of the second connecting rod being hingedly connected to the rear part of the seat cushion framework and the first upper rail, respectively, and one end of the second connecting rod remote from the seat cushion framework being connected to the first upper rail so as to be able to slide forward and backward thereon, two groups of both the first connecting rod and the second connecting rod being symmetrically provided, the other group of the first connecting rod and the second connecting rod being located between the seat cushion framework and the second upper rail, the rear part of the seat cushion framework being provided with a supporting transverse rod, two ends of the supporting transverse rod being rotatably connected to upper ends of the two second connecting rods, respectively, and an inner side of the first upper rail being provided with a second driving assembly for driving the second connecting rod on the first upper rail to slide forward and backward on the first upper rail, to drive the seat cushion framework to move forward and backward relative to the first upper rail and the second upper rail.

Preferably, the first upper rail and the second upper rail are both provided with a sliding slot extending along the lengths thereof, and ends of the two second connecting rods that are remote from the seat cushion framework are respectively hingedly connected to the first upper rail and the second upper rail by two pins, the two pins being supported in the corresponding sliding slots so as to be able to slide forward and backward therein.

Preferably, the sliding slot is configured as a wave-shaped structure, comprising an inclined section, a first transition section, a first horizontal section, a second transition section and a second horizontal section, which are successively connected from the front to the rear, and the height at a front end of the inclined section is lower than the height at a rear end.

Preferably, the second driving assembly comprises a first electric motor, a first lead screw that is driven to rotate by the first electric motor, and a first nut sleeve that is threaded onto the first lead screw, a base of the first electric motor being rotatably fitted on the first upper rail, the first lead screw extending backward along the length of the first upper rail, and the first nut sleeve being rotatably connected to the corresponding pin by means of a supporting component.

Preferably, the height adjustment mechanism comprises a third driving assembly that is arranged on an inner side of the second upper rail, the third driving assembly being used for driving the first connecting rod and the second connecting rod on the second upper rail to rotate upward or downward, and locking the first connecting rod and the second connecting rod to drive the seat cushion framework to move up or down relative to the upper sliding rail module.

Preferably, the third driving assembly comprises a second electric motor, a second lead screw that is driven to rotate by the second electric motor, and a second nut sleeve that is threaded onto the second lead screw, a base of the second electric motor being rotatably fitted on the seat cushion framework, and the second nut sleeve being rotatably connected to the corresponding pin by means of a connecting rod.

Preferably, the base of the second electric motor is rotatably fitted to the front part of the seat cushion framework by means of an adapter, and the second lead screw extends backward along the length of the second upper rail.

Preferably, the first connecting rod and the second connecting rod are arranged obliquely rearward in an initial state, and the height at front ends thereof is lower than the height at the rear ends.

Preferably, the first upper rail and the second upper rail are fixedly supported with a transverse beam therebetween.

The beneficial effects of the present invention compared to the prior art are:
1. With the automobile front seat provided by the present invention, the seat cushion framework and the backrest are fitted to different structural bases of the upper sliding rail module, and the seat cushion framework as a whole can be driven to move forward individually by the front-rear adjustment mechanism, thereby eliminating interference with the space under the backrest framework, providing the backrest framework with space to fold forward, enabling the backrest framework to be flattened forward at a large angle, increasing the space for the rear passenger to move and riding comfort. Further, the seat cushion framework can be driven to move vertically by the height adjustment mechanism, thereby realizing a height adjustment function of the seat cushion framework, ensuring riding comfort of the front passenger. In addition, by raising the seat cushion framework upward, a height difference between a seat cushion back end and the backrest can be addressed when the backrest framework is flattened backward, ensuring the comfort of the waist and buttocks of a user when lying flat, further improving the user's experience.
2. With the automobile front seat provided by the present invention, by means of a rational layout, it is possible, with fewer parts, to integrate the buttocks raising function, height adjustment function and forward moving function of the seat cushion in a seat, such that the entire seat is arranged compactly, allowing for more arrangement requirements to be taken into consideration.

### BRIEF DESCRIPTION OF THE DRAWINGS

FIG. 1 is a structural schematic drawing of an automobile front seat;

FIG. 2 is a side view of an automobile front seat in a sitting posture state;

FIG. 3 is a side view of an automobile front seat in a folded state;

FIG. 4 is a side view of an automobile front seat in a state in which a seat cushion framework 3 is adjusted to a maximum height position;

FIG. 5 is a top view of an automobile front seat;

FIG. 6 is a cutaway view of an automobile front seat in a sitting posture state (to reveal a second driving assembly 6);

FIG. 7 is a cutaway view of an automobile front seat in a folded state;

FIG. 8 is another cutaway view of an automobile front seat in a sitting posture state (to reveal a third driving assembly 7);

FIG. 9 is a cutaway view of an automobile front seat in a state in which a seat cushion framework 3 is adjusted to a maximum height position;

FIG. 10 is a structural schematic drawing of a sliding rail assembly 1;

FIG. 11 is a side view of a second lower rail 14 and a second upper rail 13.

### DETAILED DESCRIPTION OF EMBODIMENTS

The present invention is explained further below with reference to the embodiments and accompanying drawings.

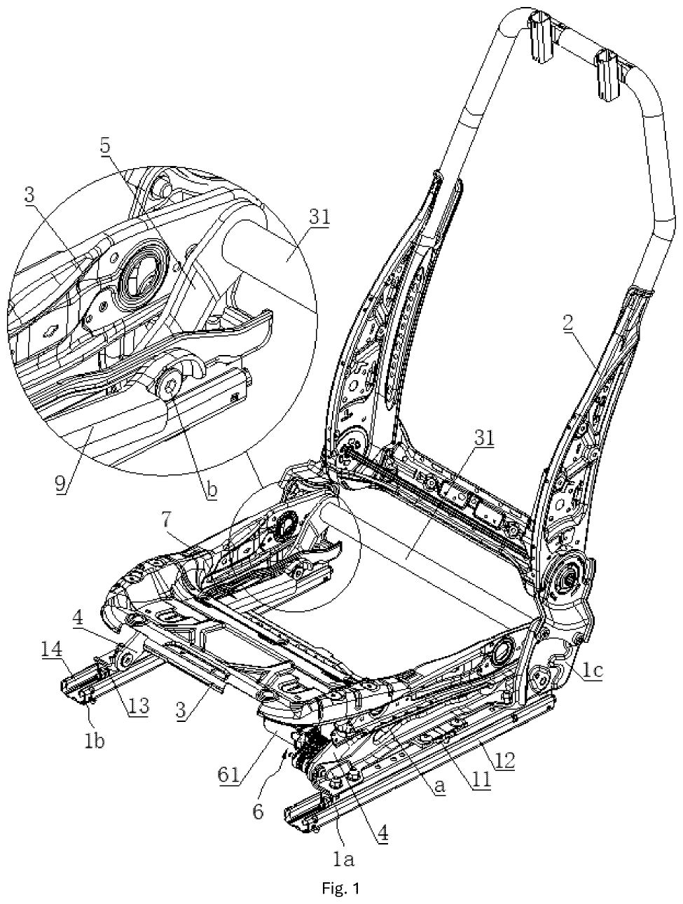

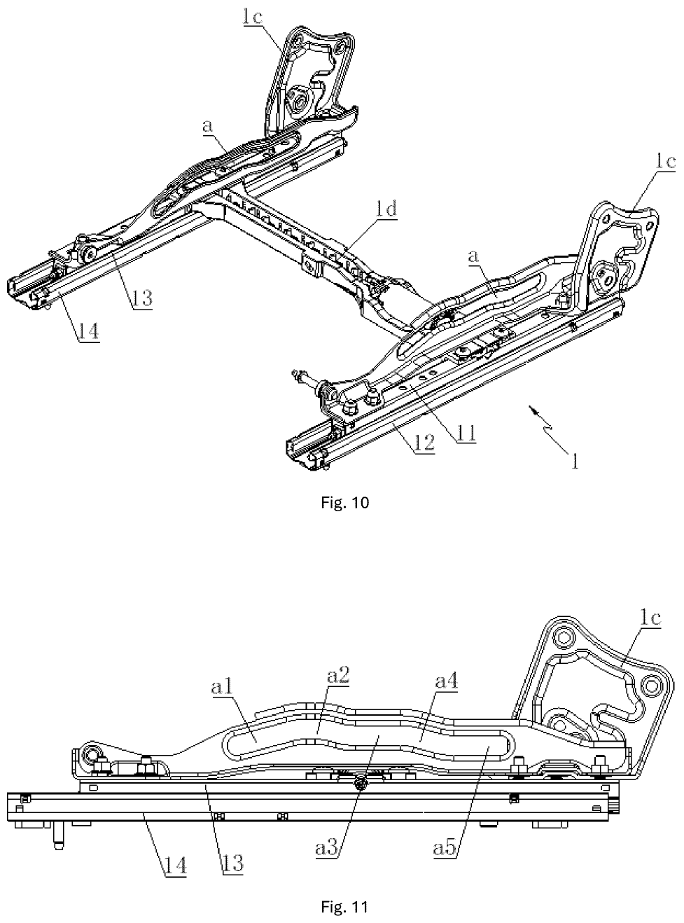

As shown in FIGS. 1 and 10, an automobile front seat comprises a sliding rail assembly 1, a backrest framework 2 and a seat cushion framework 3, wherein the sliding rail assembly 1 comprises a lower sliding rail module 1b and an upper sliding rail module 1a slidingly arranged on the lower sliding rail module 1b, the lower sliding rail module 1b being used for fitting to an automobile floor, a rear end of the upper sliding rail module 1a being fixedly provided with an adapter component 1c that extends upward, and the backrest framework 2 being rotatably mounted on the adapter component 1c. The backrest framework 2 is provided with a first driving assembly (not shown), which is capable of driving the backrest framework 2 to rotate forward or backward relative to the adapter component 1c. The first driving assembly which drives the seat backrest to rotate forward and backward may be an electric angle adjuster, which is prior art and will not be described further here. The seat cushion framework 3 is located on an upper side of the upper sliding rail module 1a, a height adjustment mechanism being provided between the seat cushion framework 3 and the upper sliding rail module 1a, and the height adjustment mechanism being capable of driving the seat cushion framework 3 to move vertically relative to the upper sliding rail module 1a, and locking the seat cushion framework 3 at a suitable height. A front-rear adjustment mechanism is provided between the seat cushion framework 3 and the upper sliding rail module 1a, and this front-rear adjustment mechanism is capable of driving the seat cushion framework 3 to move forward and backward relative to the upper sliding rail module 1a.

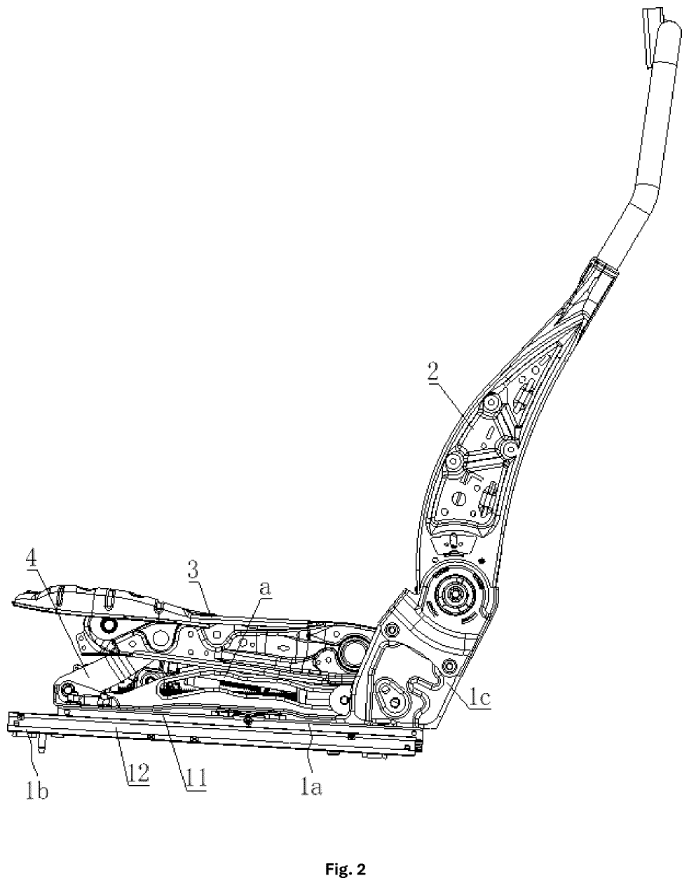

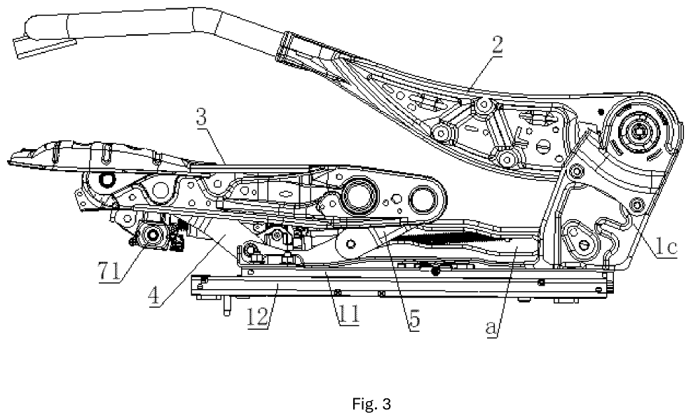

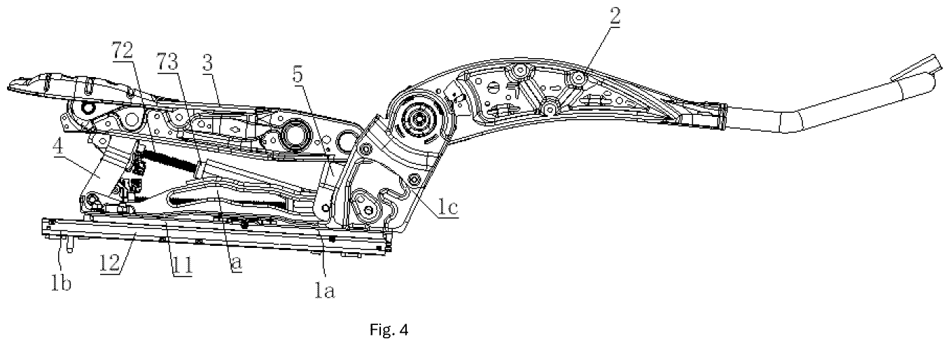

Based on the above structural design, as shown in connection with FIGS. 2 to 4, the seat cushion framework 3 and the backrest framework 2 are fitted to different structural bases of the upper sliding rail module 1a, and the seat cushion framework 3 as a whole can be driven to move forward relative to the two upper rails by the front-rear adjustment mechanism, thereby eliminating interference with the space under the backrest framework 2, providing the backrest framework 2 with space to fold forward, enabling the backrest framework 2 to be flattened forward at a large angle (see FIG. 3), increasing the space for the rear passenger to move and riding comfort. The seat cushion framework 3 further can then be driven to move vertically by the height adjustment mechanism, which realizes a height adjustment function of the seat cushion framework 3, which can thereby adjust the front passenger's view and riding comfort. In addition, it can be seen from FIG. 4 that by raising the seat cushion framework 3 upward, a height difference between a seat cushion back end and the backrest can be addressed when the backrest framework 2 is flattened backward, ensuring the comfort of the waist and buttocks of a user when lying flat, further improving the user's experience.

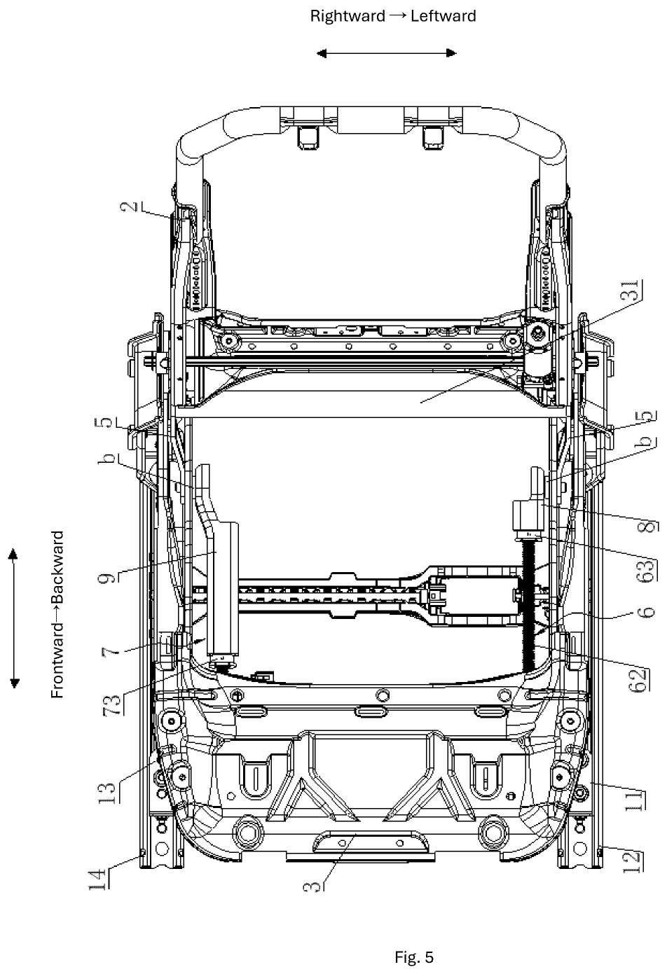

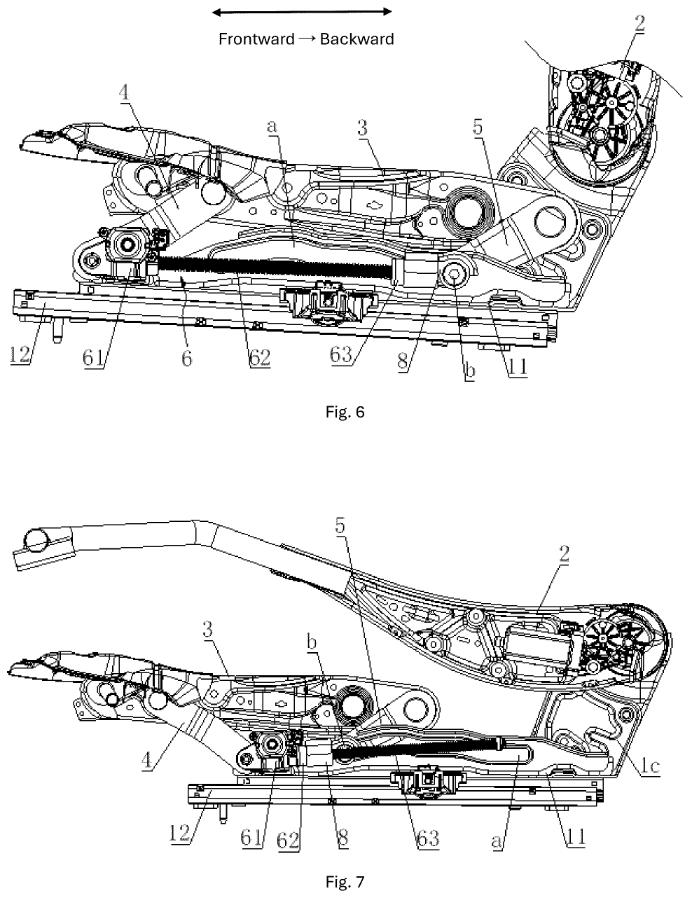

Further, as further shown in FIGS. 1 and 10, the lower sliding rail module 1b comprises a first lower rail 12 and a second lower rail 14 arranged in parallel, and the upper sliding rail module 1a comprises a first upper rail 11 slidably connected to the first lower rail 12, and a second upper rail 13 slidably connected to the second lower rail 14, the first upper rail 11 and the second upper rail 13 being fixedly supported with a transverse beam 1d, to facilitate driving the two upper rails to slide backward and forward simultaneously. In view of FIGS. 5 and 6, the front-rear adjustment mechanism comprises a first connecting rod 4 that is arranged between the front part of the seat cushion framework 3 and the first upper rail 11, an upper end of the first connecting rod 4 being hingedly connected to the front part of the seat cushion framework 3, and the lower end being hingedly connected to the front end of the first upper rail 11. A second connecting rod 5 is provided between the rear part of the seat cushion framework 3 and the first upper rail 11, the upper end of the second connecting rod 5 being hingedly connected to the rear part of the seat cushion framework 3, the lower end being hingedly connected to the rear part of the upper sliding rail module 1a, and the lower end of the second connecting rod 5 being connected to the first upper rail 11 so as to be able to slide forward and backward thereon. In the present embodiment, the first connecting rod 4 and the second connecting rod 5 are both symmetrically provided in two groups, and the other group of the first connecting rod 4 and the second connecting rod 5 is located between the seat cushion framework 3 and the second upper rail 13. The rear part of the seat cushion framework 3 is provided with a supporting transverse rod 31; two ends of this supporting transverse rod 31 are rotatably connected to the upper ends of the two second connecting rods 5, respectively. In this way, when one of the connecting rods of one side moves, the connecting rod of the other side can be driven to move synchronously. A second driving assembly 6 is provided at an inner side of the first upper rail 11, the second driving assembly 6 being capable of driving the lower end of the second connecting rod 5 on the left side to slide backward and forward on the first upper rail 11, and driving the lower end of the second connecting rod 5 on the right side to synchronously slide backward and forward on the second upper rail 13 under the linkage action of the supporting transverse rod 31, thereby driving the rear part of the seat cushion framework 3 to move backward and forward. As can be seen in connection with FIG. 7, in the process of the second driving assembly 6 driving the rear part of the seat cushion framework 3 to move forward, the two first connecting rods 4 can both rotate about the centre of the hinge connection thereof to the corresponding upper rail, thereby driving the front part of the seat cushion framework 3 to move forward. When it is necessary to flatten the backrest forward, the seat cushion framework 3 is first controlled by the second driving assembly 6 to move forward, and then the backrest framework 2 is driven by the first driving assembly to rotate forward to be fully flattened. Conversely, when the seat is restored to a sitting posture state, the backrest framework 2 is first driven to rotate backward to an upright state, and then the seat cushion framework 3 is controlled by the second driving assembly 6 to move backward.

Still further, referring to FIG. 10, a sliding slot a is provided on both the first upper rail 11 and the second upper rail 13 extending along the lengths thereof, and, further referring to FIGS. 6 and 8, lower ends of the two second connecting rods 5 are respectively hingedly connected to the first upper rail 11 and the second upper rail 13 by two pins b, the two pins b being supported in the sliding slots a of the corresponding upper rail so as to be able to slide forward and backward therein. The second driving assembly 6 drives the pin b of the second connecting rod 5 on the left side to slide backward and forward in the corresponding sliding slot a, which, under the linkage action of the supporting transverse rod 31, can drive the pin b of the second connecting rod 5 of the right side to slide synchronously in the corresponding sliding slot a. So designed, the sliding slot a has a guiding and limiting function, which enables the forward movement of the seat cushion framework 3 to be more smooth and precise.

Further referring to FIG. 6, the second driving assembly 6 comprises a first electric motor 61, a first lead screw 62 that is driven to rotate by the first electric motor 61, and a first nut sleeve 63 that is threaded onto the first lead screw 62, wherein a base of the first electric motor 61 is rotatably fitted on the first upper rail 11, the first lead screw 62 extends backward along the length of the first upper rail 11, and the first nut sleeve 63 is rotatably connected to the corresponding pin b by means of a supporting component 8, and the first nut sleeve 63 and the supporting component 8 maintain a fixed connection. In the present embodiment, the centre of the hinge connection of the base of the first electric motor 61 and the first upper rail 11 coincides with the centre of the hinge connection of the first connecting rod 4 and the first upper rail 11. As can be seen from FIG. 7, the first electric motor 61 drives the first nut sleeve 63 to move forward along the length of the first lead screw 62, which can drive the seat cushion framework 3 to move forward along the length of the sliding slot a.

Referring to FIG. 11, in the present embodiment, the sliding slot a is configured as a wave-shaped structure, comprising an inclined section a1, a first transition section a2, a first horizontal section a3, a second transition section a4 and a second horizontal section a5, which are successively connected from the front to the rear, wherein a height of a front end of the inclined section a1 to a horizontal plane is lower than the height at the rear end, the first transition section a2 is an arc section, and the second transition section a4 is inclined downward backward. When the seat is in the sitting posture state, the pin b is located at the most rearward end of the sliding slot a (see FIG. 6), and, in the process of the second driving assembly 6 driving the rear part of the seat cushion framework 3 to move forward, the pin b slides from the most rearward end to the most forward end under the guidance of the sliding slot a (see FIG. 7); that is, the seat cushion framework 3 is driven to first move slowly forward horizontally and then downward. Since the seat cushion design of an automobile seat is usually tilted slightly back down, such a path of motion can further increase the folding space under the backrest framework 2 to ensure that the backrest framework 2 can be flattened forward.

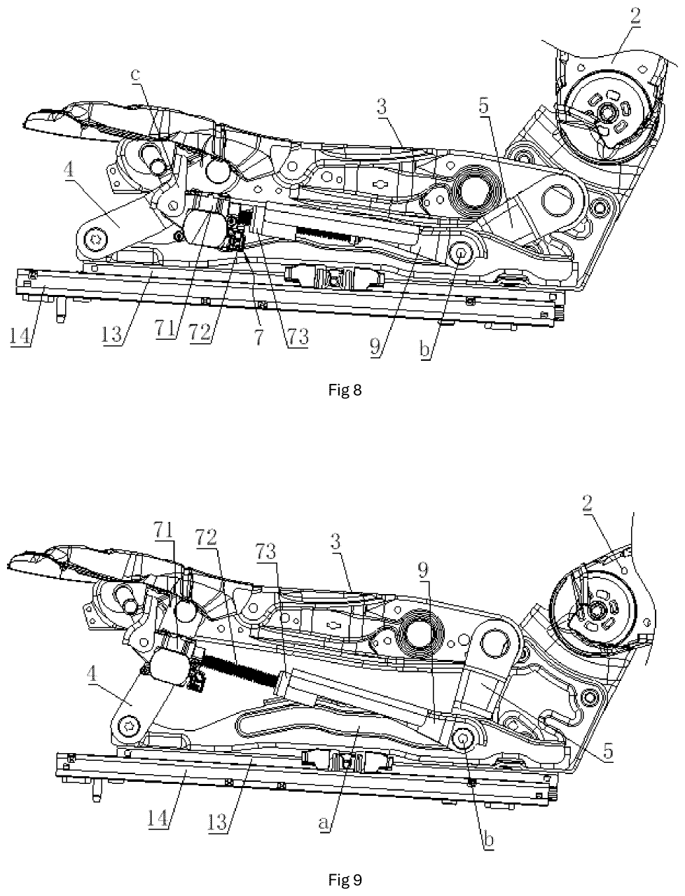

As shown in FIGS. 1 and 5, the height adjustment mechanism comprises a third driving assembly 7 that is arranged on an inner side of the second upper rail 13; this third driving assembly 7 is capable of driving the first connecting rod 4 and the second connecting rod 5 on the second upper rail 13 to rotate upward and lock the first connecting rod 4 and the second connecting rod 5, and then under the linkage action of the supporting transverse rod 31, drive the first connecting rod 4 and the second connecting rod 5 on the first upper rail 11 to synchronously rotate upward and lock, thereby driving the seat cushion framework 3 to lift up relative to the two upper rails (see FIG. 9). Next, the first connecting rod 4 and the second connecting rod 5 on the second upper rail 13 are driven to rotate downward, and the seat cushion framework 3 can be driven downward back to the starting position.

Further, referring to FIG. 8, the third driving assembly 7 comprises a second electric motor 71, a second lead screw 72 that is driven to rotate by the second electric motor 71, and a second nut sleeve 73 that is threaded onto the second lead screw 72, wherein a base of the second electric motor 71 is rotatably fitted on a front part of the seat cushion framework 3 by means of an adapter member c, the second lead screw 72 extends backward along the length of the second upper rail 13, and the second nut sleeve 73 is fixedly provided with a connecting rod 9, and a rear end of this connecting rod 9 is rotatably connected to the pin b. So designed, the third driving assembly 7 is not affected by the operation of the second driving assembly 6. In conjunction with FIG. 9, the second electric motor 71 drives the second nut sleeve 73 to move backward along the second lead screw rod 72, which can force the first connecting rod 4 and the second connecting rod 5 to synchronously rotate upward around the centre of the respective hinge connection thereof with the second upper rail 13, i.e., can drive the seat cushion framework 3 as a whole to lift up relative to the upper rail module 1a. Next, the second electric motor 71 further drives the second nut sleeve 73 to move forward along the second lead screw 72; since the second driving assembly 6 can control the sliding of the pin b in the corresponding sliding slot a, the second driving assembly 6 is capable of locking the lower end of the corresponding second connecting rod 5 at the rear end of the sliding slot a, and, when the second nut sleeve 73 drives the connecting rod 9 to move forward, this can force the first connecting rod 4 and the second connecting rod 5 to synchronously rotate backward and downward around the centre of the respective hinge connection thereof with the second upper rail 13, thereby driving the seat cushion framework 3 as a whole to move downward to the initial position.

Referring to FIG. 6, in the initial state, i.e. when the seat cushion framework 3 has not been moved forward and height-adjusted, the first connecting rod 4 is arranged obliquely between the front part of the seat cushion framework 3 and the first upper rail 11, and the height of the front end thereof is lower than the height of the rear end; that is, with the seat in the sitting posture state, the upper end of the first connecting rod 4 with a backward tilt is hingedly connected to the front part of the seat cushion framework 3. The advantage of this design is that, when the seat cushion framework 3 is moved forward, the first connecting rod 4 is first rotated upward from the rear and then downward, centred on the hinge point at the lower end thereof, ensuring a maximum rotation angle of the first connecting rod 4, such that the first connecting rod 4 can move the seat cushion framework 3 as far forward as possible (see FIG. 7). In addition, when the upper end of the first connecting rod 4 is rotated upward to the highest point, the rear part of the seat cushion framework 3 is enabled to have a downward inclined state, further increasing the space for the backrest framework 2 to fold downward; thereafter, the first connecting rod 4 continues to rotate downward, and the seat cushion framework 3 can be moved forward and then downward as a whole, that is, maximally ensuring clearance space for the seat cushion framework 3, increasing the angle at which the backrest framework 2 is tipped forward, thereby providing sufficient space for the rear passenger to move, thus increasing the riding comfort of the rear passenger.

Further, again referring to FIG. 8, the second connecting rod 5 is arranged obliquely between the rear part of the seat cushion framework 3 and the upper rail 11, and likewise, with the seat in the sitting posture state, the upper end of the second connecting rod 5 with a backward tilt is hingedly connected to the rear part of the seat cushion framework 3. So designed, when the second electric motor 71 drives the second nut sleeve 73 to move backward along the second lead screw rod 72, this can ensure that the first connecting rod 4 and the second connecting rod 5 synchronously rotate upward around the centre of the respective hinge connection thereof with the upper rail.

Referring again to FIGS. 1 and 5, by means of the structural layout of the second driving assembly 6 and the third driving assembly 7 described above, it is possible, with fewer parts, to integrate the height adjustment function and forward moving function of the seat cushion and the buttocks raising function into the interior of the same seat, increasing the compactness of the interior structure of the seat cushion, such that the entire seat is arranged compactly, allowing for more arrangement requirements to be taken into consideration. At the same time, it is also possible to select a corresponding structural match according to different functional requirements; for example, when only a single seat cushion height adjustment function or seat cushion forward moving function is required, only the second driving assembly 6 or the third driving assembly 7 is optionally assembled, such that the choice of structure is richer and more adaptable.

Finally, it should be noted that the foregoing merely describes preferred embodiments of the present invention, and that those skilled in the art, under the teachings of the present invention, without departing from the purpose and claims thereof, may make various similar representations, and such transformations all fall within the scope of protection of the present invention.

The present invention discloses an automobile front seat, comprising a sliding rail assembly, the sliding rail assembly comprising a lower sliding rail module and an upper sliding rail module, the lower sliding rail module being used for fitting to an automobile floor, and a rear end of the upper sliding rail module being fixedly provided with an adapter component that extends upward; a backrest framework is rotatably mounted on the adapter component, and a first driving assembly that drives the backrest framework to rotate is provided on the backrest framework; a seat cushion framework is provided on an upper side of the upper sliding rail module, a height adjustment mechanism being provided between the seat cushion framework and the upper sliding rail module, the height adjustment mechanism being used for driving adjustment of the seat cushion framework to move vertically relative to the upper sliding rail module, a front-rear adjustment mechanism being provided between the seat cushion framework and the upper sliding rail module, and the front-rear adjustment mechanism being used for driving the seat cushion framework to move forward and backward relative to the upper rail module. A beneficial effect of the present invention is that the seat cushion can have both forward moving and height adjustment functions, having the advantages of strong practicality and good comfort.

What is claimed is:

1. Automobile front seat, characterized by comprising:
a sliding rail assembly, the sliding rail assembly comprising a lower sliding rail module and an upper sliding rail module slidingly arranged on the lower sliding rail module, the lower sliding rail module being used for fitting to an automobile floor, and a rear end of the upper sliding rail module being fixedly provided with an adapter component that extends upward;
a backrest framework that is rotatably mounted on the adapter component, a first driving assembly being provided on the backrest framework, and the first driving assembly being used for driving the backrest framework to rotate forward or backward;
and a seat cushion framework that is located on an upper side of the upper sliding rail module, a height adjustment mechanism being provided between the seat cushion framework and the upper sliding rail module, the height adjustment mechanism being used for driving the seat cushion framework to move vertically relative to the upper sliding rail module, a front-rear adjustment mechanism being provided between the seat cushion framework and the upper sliding rail module, and the front-rear adjustment mechanism being used for driving the seat cushion framework to move forward and backward relative to the upper rail module.

2. Automobile front seat according to claim 1, characterized in that: the lower sliding rail module comprises a first lower rail and a second lower rail arranged in parallel, and the upper sliding rail module comprises a first upper rail and a second upper rail slidably connected to the first lower rail and the second lower rail, respectively;
the front-rear adjustment mechanism comprises a first connecting rod that is arranged between a front part of the seat cushion framework and the first upper rail, two ends of the first connecting rod being respectively hingedly connected to the front part of the seat cushion framework and the first upper rail, a second connecting rod being provided between a rear part of the seat cushion framework and the first upper rail, two ends of the second connecting rod being hingedly connected to the rear part of the seat cushion framework and the first upper rail, respectively, and one end of the second connecting rod remote from the seat cushion framework being connected to the first upper rail so as to be able to slide forward and backward thereon, two groups of both the first connecting rod and the second connecting rod being symmetrically provided, the other group of the first connecting rod and the second connecting rod being located between the seat cushion framework and the second upper rail, the rear part of the seat cushion framework being provided with a supporting transverse rod, two ends of the supporting transverse rod being rotatably connected to upper ends of the two second connecting rods, respectively, and an inner side of the first upper rail being provided with a second driving assembly for driving the second connecting rod on the first upper rail to slide forward and backward on the first upper rail, to drive the seat cushion framework to move forward and backward relative to the first upper rail and the second upper rail.

3. Automobile front seat according to claim 2, characterized in that: the first upper rail and the second upper rail are both provided with a sliding slot extending along the lengths thereof, and ends of the two second connecting rods that are remote from the seat cushion framework are respectively hingedly connected to the first upper rail and the second upper rail by two pins, the two pins being supported in the corresponding sliding slots so as to be able to slide forward and backward therein.

4. Automobile front seat according to claim 3, characterized in that: the sliding slot is configured as a wave-shaped structure, comprising an inclined section, a first transition section, a first horizontal section, a second transition section and a second horizontal section, which are successively connected from the front to the rear, and the height at a front end of the inclined section is lower than the height at a rear end.

5. Automobile front seat according to claim 3, characterized in that: the second driving assembly comprises a first electric motor, a first lead screw that is driven to rotate by the first electric motor, and a first nut sleeve that is threaded onto the first lead screw, a base of the first electric motor being rotatably fitted on the first upper rail, the first lead screw extending backward along the length of the first upper rail, and the first nut sleeve being rotatably connected to the corresponding pin by means of a supporting component.

6. Automobile front seat according to claim 2, characterized in that: the height adjustment mechanism comprises a third driving assembly that is arranged on an inner side of the second upper rail, the third driving assembly being used for driving the first connecting rod and the second connecting rod on the second upper rail to rotate upward or downward, and locking the first connecting rod and the second connecting rod to drive the seat cushion framework to move up or down relative to the upper sliding rail module.

7. Automobile front seat according to claim 6, characterized in that: the third driving assembly comprises a second electric motor, a second lead screw that is driven to rotate by the second electric motor, and a second nut sleeve that is threaded onto the second lead screw, a base of the second electric motor being rotatably fitted on the seat cushion framework, and the second nut sleeve being rotatably connected to the corresponding pin by means of a connecting rod.

8. Automobile front seat according to claim 7, characterized in that: the base of the second electric motor is rotatably fitted to the front part of the seat cushion framework by means of an adapter, and the second lead screw extends backward along the length of the second upper rail.

9. Automobile front seat according to claim 2, characterized in that: the first connecting rod and the second connecting rod are arranged obliquely rearward in an initial state, and the height at front ends thereof is lower than the height at the rear ends.

10. Automobile front seat according to claim 1, characterized in that: the first upper rail and the second upper rail are fixedly supported with a transverse beam therebetween.
